(19) United States
(12) Patent Application Publication
(10) Pub. No.: US 2002/0138397 A1
(43) Pub. Date: Sep. 26, 2002

(54) Sale of agricultural products with deferred pricing and delivery

(76) Inventors: Jeffery Seeley, Chanhassen, MN (US); Dennis Inman, Eden Prairie, MN (US)

Correspondence Address: SHUMAKER & SIEFFERT, P. A., 8425 SEASONS PARKWAY, SUITE 105, ST. PAUL, MN, 55125, US

(21) Appl. No.: 09/814,470

(22) Filed: Mar. 21, 2001

(51) Int. Cl. G06F 17/60; G06F 17/00

(52) U.S. Cl. 705/37; 705/500

(57) ABSTRACT

In accordance with the invention, an agricultural producer agrees to sell, price and deliver a quantity of an agricultural product to a buyer at a future date. The agricultural producer further agrees to price the quantity at an agreed-upon maximum price in the event the market price is equal to or above the maximum price on a target date. In the event the market price is below the maximum price on the target date, however, the agricultural producer may elect to defer pricing and/or delivery of the quantity beyond the target date, to try to take advantage of market conditions after the target date. In any event, the agricultural producer must price the quantity of agricultural product before a fixed final pricing date and must deliver the quantity of agricultural product before a fixed final delivery date.

### TECHNICAL FIELD

The invention relates to the agriculture business and, more particularly, to transactions involving the exchange of agricultural products as market commodities.

### BACKGROUND

Agricultural producers face substantial risks in producing an agricultural product, bringing it to market, and earning a profit. Individual farmers, for example, are especially susceptible to risk factors that can adversely affect yield, marketability, and market price. Risk factors include weather conditions such as drought, hail, wind, frost, and excess rain, plant disease, insects, market volatility, increased global capacity, and government regulations. To offset some of the risks associated with market volatility, many producers enter into marketing agreements with buyers of agricultural products.

In one kind of marketing agreement, called a “cash contract,” an agricultural producer and a buyer enter into a sales agreement for the immediate or future delivery of a quantity of agricultural products. A typical cash contract is a “forward sale” agreement, in which the agricultural producer agrees to sell and the buyer agrees to buy a quantity of agricultural product at a future time in exchange for a fixed price. A forward sale agreement typically includes terms requiring the physical delivery of the agricultural product to a specific site at a specific time. Forward sale contracts are privately negotiated and need not be standardized.

In another kind of marketing agreement, called a “futures contract,” most terms of the transaction are standardized, including terms pertaining to commodity, quality, delivery date and delivery point. The price in a futures contract is not standardized, however, and is influenced in the market by supply and demand. Futures contracts are agreements made on the trading floor or electronic platform of a futures exchange, and the futures prices are publicly reported. A futures price typically is reported along with the futures contract month, i.e., the month of delivery in the standardized futures contract. An agricultural producer may market his agricultural product by buying and selling futures contracts, options on futures contracts, and any combination thereof.

Many agricultural producers choose to sell part or all of their agricultural products on the open market without a pre-arranged marketing agreement. In a typical grain sale of this kind, for example, the agricultural producer delivers the grain to a local elevator and receives a cash price. The cash price is a function of the market price that day. The “market price” is typically a price for futures of the commodity for a contract month, such as the price of December corn futures. The cash price may be generally defined as the market price minus basis, in which basis reflects the buyer's expenses such as handling, storing and transporting the agricultural product. In some cases, adjustments such as quantity and quality discounts or premiums also may come into play in calculating the cash price.

In many years, the market price available on a given day is lower than the price an agricultural producer could have received through a pre-arranged marketing agreement. In some years, however, the market price is unusually high. Traditionally, a buyer may wish to protect itself from high prices by entering into a marketing agreement with an agricultural producer, in which the buyer obtains the right but not the obligation to buy a specified quantity of agricultural product from the agricultural producer on a specified target date at a fixed maximum price if the market price on that target date is greater than or equal to the maximum price.

In exchange for this right to buy at a fixed maximum price, the buyer provides the agricultural producer with consideration such as an up-front cash payment. In most years, the market price on the target date will be less than the maximum price, and the right to buy at the maximum price is thereby rendered worthless. In those years, the buyer may not be obligated to accept delivery from the agricultural producer, and/or the agricultural producer may not be obligated to sell to the buyer, the agricultural product.

The result may be uncertainty to both the buyer and the agricultural producer. If the agricultural producer is not be obligated to sell to the buyer, the buyer may be unable to ensure an adequate supply of the agricultural product. The agricultural producer will have worked to produce the agricultural product in case it became necessary for him to sell to the buyer at the maximum price. If the market price is below the maximum price on the target date and the buyer is not obligated to accept delivery from the agricultural producer, the agricultural producer will be uncertain about whether the buyer will accept delivery of the agricultural product.

### SUMMARY

The invention is directed to methods for transacting exchanges of agricultural products between an agricultural producer and a buyer. The methods are designed to provide benefits to both the agricultural producer and the buyer, including certainty of sale. In a typical application, the invention allows the agricultural producer and the buyer to benefit from a transaction involving a single quantity of an agricultural product. In another typical application, the invention allows the agricultural producer and the buyer to benefit from transactions involving two quantities of one or more agricultural products.

In accordance with an embodiment of the invention, an agricultural producer receives consideration from the buyer. The consideration may come in many forms, such as an up-front cash payment, a premium on a transaction for another quantity of agricultural product, or an adjustment to price or basis. In exchange for the consideration, the agricultural producer agrees to sell, price and deliver a quantity of the agricultural product to the buyer at a target date. On that target date, the agricultural producer will deliver the agreed-upon quantity of agricultural product to the buyer at an agreed-upon maximum price if the market price on the target date is above or equal to the maximum price.

The agreement further provides that in the event the market price is below the maximum price on the target date, the agricultural producer may price and deliver the quantity of agricultural product to the buyer at the market price, and the buyer will accept delivery of the quantity. Alternatively, when the market price is below the maximum price on the target date, the agricultural producer may elect to defer pricing and/or delivery of the quantity beyond the target date. The agricultural producer must price the quantity of agricultural product before a fixed final pricing date and must deliver the quantity of agricultural product before a fixed final delivery date.

When the agricultural producer defers pricing, he does so in hopes that the market price will increase. The agricultural producer ultimately prices the quantity and earns the then-existing market price. The agricultural producer therefore benefits from the opportunity to obtain more favorable pricing. The agricultural producer also benefits from the consideration provided by the buyer, and from the certainty of the transaction. The buyer likewise benefits from the certainty of the transaction and further benefits from paying a below-market price when the market price on the target date is above the maximum price.

In one embodiment, the invention provides a method for transacting exchanges of agricultural products between an agricultural producer and a buyer. The method comprises providing consideration to an agricultural producer. The method further comprises defining a quantity of an agricultural product, a maximum price and a target date. In the event the market price is less than the maximum price on the target date, the method includes receiving from the agricultural producer an election to defer pricing of the quantity beyond the target date. In the event the market price exceeds the maximum price on the target date, the method may comprise paying to the agricultural producer a sum based upon the maximum price. The method may further comprise the buyer receiving notification of pricing of the quantity from the agricultural producer no later than a final pricing date, the final pricing date being defined in the agreement. The method may also comprise receiving delivery of the quantity from the agricultural producer no later than a final delivery date, the final delivery date being defined in the agreement. The final pricing date and the final delivery date may be defined to be the same date.

In a related embodiment, the invention comprises a method for transacting exchanges of agricultural products between an agricultural producer and a buyer, the method comprising complimentary activities of the previous embodiment. These activities include receiving consideration from a buyer, and electing to defer pricing of the quantity beyond the target date in the event the market price is less than the maximum price on the target date. The activities may also include notifying the buyer of pricing of the quantity no later than a final pricing date and delivering the quantity to the buyer no later than a final delivery date.

In another embodiment, the invention provides a method comprising paying a first sum for a first quantity of a first agricultural product delivered on a first date. The first sum is based on a first market price for a first delivery date plus a premium. The method further comprises paying a second sum for a second quantity of a second agricultural product. The second sum is based either on: the lesser of a second market price for a second date and a maximum price in the event the second quantity is priced on the second date, or a third market price for a third date in the event the second quantity is priced on the third date, the third date following the second date. The method further comprises receiving delivery of the second quantity at no later than a final delivery date.

In a further embodiment, the invention provides a method comprising defining a quantity of an agricultural product, a maximum price and a target date. The method further comprises paying to the agricultural producer a sum based upon the maximum price in the event the market price exceeds the maximum price on the target date. The method also comprises granting to the agricultural producer the choice to defer pricing of the quantity beyond the target date in the event the market price is less than the maximum price on the target date. The method may further comprise receiving delivery of the quantity no later than a final delivery date.

The details of one or more embodiments of the present invention are set forth in the accompanying drawings and the description below. Other features, objects, and advantages of the present invention will be apparent from the description and drawings, and from the claims.

### DESCRIPTION OF DRAWINGS

FIG. 1 is a diagram illustrating an interaction between an agricultural producer and a buyer.

FIG. 2 is a flow chart illustrating an embodiment of the invention.

### DETAILED DESCRIPTION

The invention presents techniques for transacting exchanges of agricultural products between an agricultural producer and a buyer. The term “agricultural producer” may refer to any producer of agricultural products, from an individual farmer to a large corporate farming operation. “Agricultural product” produced by the agricultural producer may take the form of crops such as grain, larger vegetables, fruit, cotton, and the like. Although the commodities discussed below will center upon crops such as corn, the use of corn is simply an illustrative commodity. The invention is not limited to crops in general or to corn in particular. “Agricultural product” may further include livestock or animal produce, as well as any byproducts of the foregoing products that may be traded as commodities. A “buyer” may take the form of a grain elevator, processing plant, or other point of delivery for an agricultural producer's output, an integrated agricultural products provider, or an entity or collection of entities that purchases agricultural products and trades agricultural commodities and options on the open market.

An agricultural producer of corn, for example, may choose to sell part or all of his crop on the open market without a pre-arranged marketing agreement. The agricultural producer may make such a sale by delivering the crop to the buyer's local elevator and receiving in return a cash price, which is a function of the market price that day. With such a sale, the agricultural producer “prices” the agricultural product, i.e., fixes the market price of the agricultural product that will determine the cash price paid by the buyer, and delivers the agricultural product to the buyer at the same time. The basis, which also affects the cash price, is fixed or “established” separately. Pricing and delivery need not occur at the same time, however. For example, the agricultural producer may deliver the agricultural product to the buyer's local elevator for storage and pay a storage fee, and later choose to complete the sale by pricing the agricultural product at a market price for a later date.

In accordance with an embodiment of the invention, an agricultural producer may receive consideration from a buyer, and in exchange for consideration, the agricultural producer agrees to sell, price and deliver a quantity of the agricultural product to the buyer. The consideration may come in many forms. For example, the consideration may come in the form of an up-front cash payment, in which the agricultural producer receives an advance cash payment, and agrees to sell, price and deliver the quantity of the agricultural product to the buyer at a later date. Another form of consideration may be in the form of a premium on a transaction for a second quantity of agricultural product. A “premium” is a cash payment in addition to the market-based cash price for the second quantity. The second quantity of agricultural product may be delivered before the first quantity, at the same time as the first quantity or after the first quantity. A third form of consideration may be an adjustment to basis, which results in an increase in the cash price received by the agricultural producer. A fourth form of consideration may be an adjustment to price, instead of basis. Other forms of consideration are possible, and the invention is not limited to the particular forms of consideration that are described herein.

In addition to providing consideration, the buyer agrees to buy, receive and pay a cash price for the quantity of agricultural product. However, the price of the quantity is not fixed by the agreement. The agreement instead provides that on a specified target date, the agricultural producer will price and sell the agreed-upon quantity of agricultural product to the buyer, with the price capped at an agreed-upon maximum price. The agreement further provides that, if on the target date the market price is above or equal to the maximum price, the agricultural producer is obligated to deliver the quantity at the maximum price, foregoing opportunities to sell the quantity at the higher market price. The agreement may specify the scheduled date for delivery as the target date or another date.

Moreover, the agreement further provides that in the event the market price is below the maximum price on the target date, the agricultural producer may, at his election, deliver the quantity of agricultural product to the buyer. The buyer will accept delivery of the quantity and pay a cash price based upon the market price on the target date. Alternatively, when the market price is below the maximum price on the target date, the agricultural producer may elect to defer pricing and/or delivery of the quantity beyond the target date, i.e., to a date after the target date.

The agricultural producer may not defer pricing and delivery of the quantity indefinitely, however. Rather, the agricultural producer must price the quantity of agricultural product before a fixed final pricing date and must deliver the quantity of agricultural product before a fixed final delivery date. The final pricing date and the final delivery date need not be the same, but the two dates may be the same for convenience. The final pricing date and the final delivery date may both be set as the final day of the crop year, for example. In general, the agricultural producer prices the quantity by notifying the buyer that he will accept a cash price for the quantity based upon the current market price.

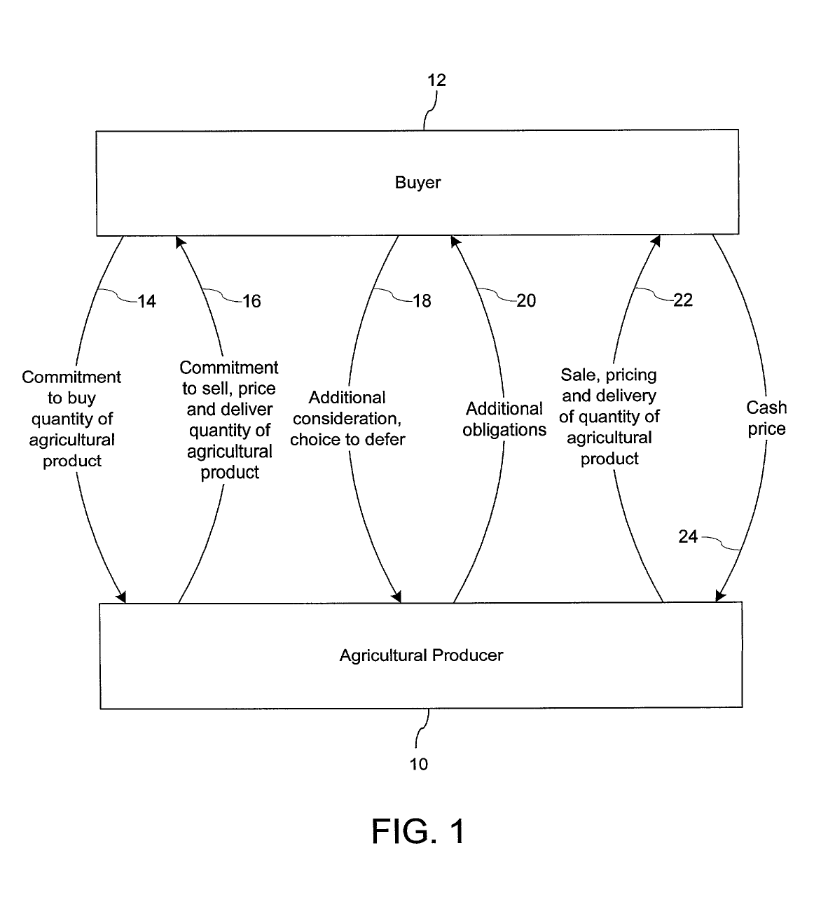

FIG. 1 is a diagram showing an interaction between agricultural producer 10 and buyer 12 and illustrating the techniques of the invention. Under the terms of an agreement between agricultural producer 10 and buyer 12, agricultural producer 10 agrees to commit to the future sale of a quantity of agricultural product to buyer 12 (16), which buyer 12 agrees to buy (14). In addition to the commitment to buy, buyer 12 agrees to provide additional consideration to agricultural producer 10 (18).

The additional consideration may be provided immediately, such as consideration in the form of an up-front cash payment. The consideration may also be provided at a later date, such as consideration in the form of an adjustment to price or basis upon delivery of the quantity.

In exchange for the consideration, agricultural producer 10 assumes additional obligations (20), including the obligations to price and deliver the quantity of agricultural product to buyer 12 and to price the price the quantity at the maximum price in the event the market price is equal to or above the maximum price on the target date. Buyer 12 also grants agricultural producer 10 a choice to defer pricing and/or delivery in the event the market price is below the maximum price on the target date (18).

At a future date, the transaction for the quantity is completed. Agricultural producer 10 sells, prices and delivers the quantity of agricultural product (22) to buyer 12, and receives a cash price in return (24). The date of completion of the transaction may be the target date or a date after the target date.

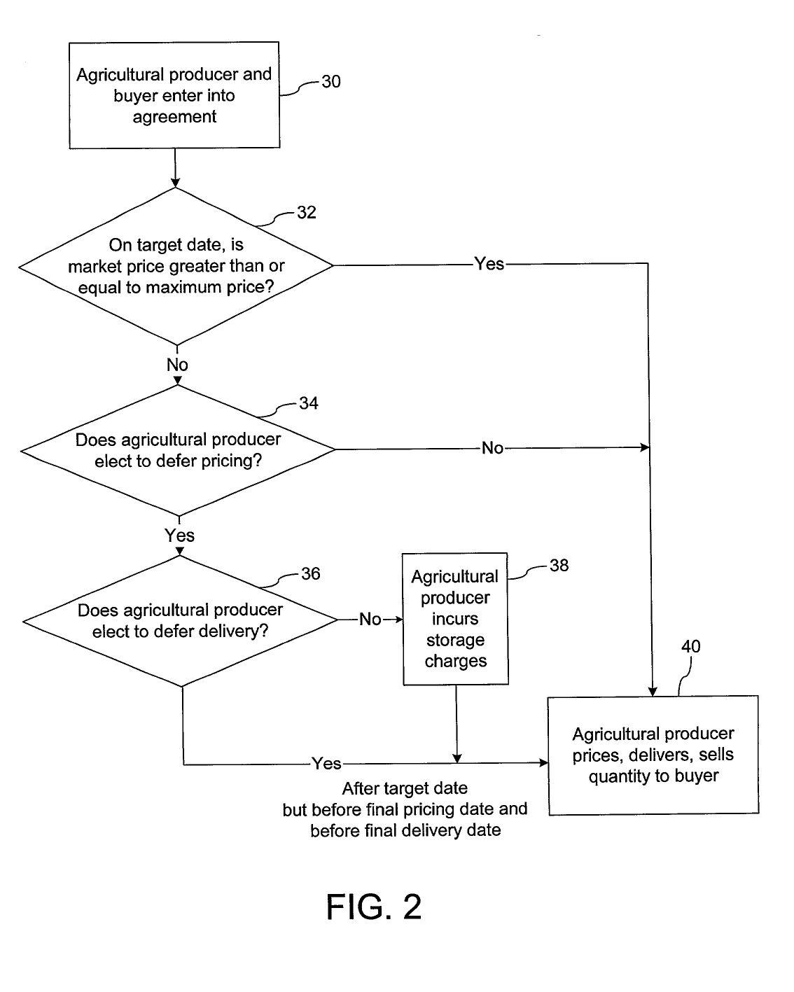

FIG. 2 is a flow diagram that illustrates the general sequence of events. Agricultural producer 10 and buyer 12 enter into an agreement (30) in which agricultural producer 10 agrees to sell and buyer 12 agrees to buy a quantity of agricultural product. Buyer further agrees to provide consideration. The provision of consideration, which may take place at any time, is not shown in FIG. 2. The agreement between agricultural producer 10 and buyer 12 sets a target date at which agricultural producer plans to price the quantity of agricultural product to buyer 12.

The agreement between agricultural producer 10 and buyer 12 further establishes a maximum price. The price for the agricultural product will be the market price on the target date, unless the market price exceeds the maximum price, in which case the price for the agricultural product will be the maximum price. If, on the target date, the market price equals or exceeds the maximum price (32), agricultural producer 10 may not defer pricing. Rather, agricultural producer 10 is obligated to deliver the quantity in return for a cash price based upon the maximum price instead of the higher market price (40).

If the market price is below the maximum price on the target date, however, agricultural producer 10 may elect to defer pricing (34) and/or delivery (36), and price the quantity of agricultural product at a market price on a later date. Agricultural producer 10 may anticipate that the market price will rise after the target date, and by electing to defer pricing (34), agricultural producer 10 obtains the benefit of a higher market price, if any. Even if the market price rises above the agreed-upon maximum price, agricultural producer 10 may price the agricultural product at the higher market price. In other words, the maximum price is in effect up to the target date, and after the target date, the maximum price is no longer effective.

The agreement provides benefits both to agricultural producer 10 and to buyer 12. First, agricultural producer 10 receives consideration from buyer 12, either immediately or at a later date. In exchange, agricultural producer 10 assumes the risk that on the target date, agricultural producer 10 may have to sell the quantity to buyer 12 at a maximum price instead of a higher market price.

A second benefit to agricultural producer 10 is the obligation of buyer 12 to accept the quantity. An obligation to accept delivery provides certainty to agricultural producer 10, who is obligated by the agreement to produce the quantity of agricultural product, and price, deliver and sell the quantity to buyer 12. An obligation to accept delivery is advantageous to agricultural producer 10 when supplies of the agricultural product are plentiful and local buyers are declining to accept deliveries. The certainty that agricultural producer 10 will, within a fixed time, price, deliver and sell the quantity to buyer 12 (40) provides certainty to buyer 12 as well.

A third benefit to agricultural producer 10 is the option to defer pricing and/or delivery when the market price is below the maximum price on the target date. By exercising the option to defer, agricultural producer 10 may be able to take advantage of later favorable market conditions. When agricultural producer 10 believes the market price will rise, for example, agricultural producer 10 may defer pricing to take advantage of a possibly higher market price. Agricultural producer 10 may also elect to defer for other reasons, such as tax reasons.

The power to defer is limited, however, in at least two respects. First, when the market price on the target date is greater than the maximum price, agricultural producer 10 may not defer pricing and delivery. In such a case, buyer 12 has the right and obligation to buy and take delivery of the quantity at or below market price, and agricultural producer 10 has the obligation to deliver and accept pricing. Second, when the market price on the target date is less than the maximum price, agricultural producer 10 may defer pricing and/or delivery but may not do so for an indefinite period. In other words, agricultural producer 10 may not avoid the obligation to price and deliver the quantity to buyer 12. Buyer 12 may not avoid the obligation to pay and take delivery. Agricultural producer 10 is obligated to price the agricultural product before a specified final pricing date, and to deliver the agricultural product before a specified final delivery date (40). In this manner, pricing and delivery of the quantity are ordinarily requirements of the agreement.

The maximum price provides value to buyer 12, in that buyer 12 may buy the quantity of agricultural product at a price below market price in some years. Even in years when the market price is well below the maximum price, the assurance to buyer 12 that there will be a future sale, combined with time limitations for pricing and delivery, provide value to buyer 12. Agricultural producer 10 may, within limits, elect to defer when the market price is below the maximum price, but in many years, agricultural producer 10 may be unwilling or unable to elect to defer. Agricultural producer 10 may be unwilling to elect to defer pricing, for example, when he believes the market price will decline after the target date. In such a case, delaying pricing would result in a lower market price and consequently a lower cash price.

In addition, deferring pricing beyond the target date may result in costs to agricultural producer 10, such as carrying charges. In general, holding a commodity entails carrying charges, such as the cost of storage, insurance, and finance charges. Agricultural producer 10 may, for example, elect to defer pricing but not delivery (36), and in such a case agricultural producer 10 delivers the quantity of agricultural product to a local elevator associated with buyer 12 for storage and pays a storage fee (38). Although agricultural producer 10 eventually completes the transaction by pricing the quantity at a market price for a later date (40), storage fees accumulate until the quantity is priced. Agricultural producer 10 may incur carrying charges or other expenses even if agricultural producer 10 stores the quantity in his own facilities.

On the target date, agricultural producer 10 may be averse to paying the carrying charges or other expenses that would accompany deferring. It may also be the case that agricultural producer 10 has an immediate need for cash. In such a case, deferring is unattractive, because deferring pricing and delivery means that the cash payment from buyer 12 will also be deferred.

In general, agricultural producer 10 may have an incentive to defer when the market price is unusually high (but below the maximum price), or when the market price is unusually low or when agricultural producer 10 believes the market price will rise substantially. When the market price is unusually high and is near but below the maximum price on the target date, agricultural producer 10 may elect to defer pricing (34) until after the target date to see whether the market price rises further, and then price the agricultural product at a higher market price. After the target date, the obligation to sell at the maximum price expires, and if the market price exceeds the maximum price after the target date, agricultural producer 10 may price the agricultural product above the maximum price. Agricultural producer 10 may incur carrying charges and other expenses as a result of deferring, but carrying charges and other expenses may be offset by the higher market price.

When the market price is unusually low on the target date, agricultural producer 10 may elect to defer to see whether the market price will improve. If the market price is so low that government subsidies come into play, agricultural producer 10 may stand little or nothing to lose from further declines in the market price, and may stand to gain if the market price rises. Once again, agricultural producer 10 may believe that waiting for a higher market price will justify incurring carrying charges and other expenses.

When the market price is below the maximum price on the target date but agricultural producer 10 believes the market price is likely to rise substantially and that the increase in the market price will outweigh carrying charges and other expenses, agricultural producer 10 may elect to defer pricing until after the target date. By deferring pricing, agricultural producer 10 may take advantage of increases in the market price after the target date, if any. Once again, the choice to defer provides agricultural producer 10 with the opportunity to obtain more favorable pricing and consequently a more favorable cash price.

A series of examples illustrate the techniques of the invention. As a first example, assume that on Nov. 1, 2001, Agricultural Producer A is considering selling 10,000 bushels of corn to a buyer, such as the local elevator. Agricultural Producer A has no pre-arranged marketing agreement for these 10,000 bushels. The market price on Nov. 1, 2001 is $2.15 per bushel. The buyer and Agricultural Producer A agree that the cash price for the 10,000 bushels will be based not upon the market price, but upon the market price plus a premium of ten cents per bushel. Consequently, the cash price received by Agricultural Producer A on Nov. 1, 2002, is based upon $2.25 per bushel.

In this scenario, the consideration provided to Agricultural Producer A is in the form of a premium on a first quantity of agricultural product, and the premium is paid up front. In exchange for the premium, Agricultural Producer A agrees to sell a second quantity of 10,000 bushels to the buyer. The target date for pricing and delivering the second quantity is Sep. 14, 2002, and the cash price for the second quantity will be based upon the market price or $2.50 per bushel, whichever is lower. If the market price is below $2.50 per bushel on Sep. 14, 2002, Agricultural Producer A may elect to defer pricing and/or delivery beyond the target date, but in no event may pricing and/or delivery be deferred beyond Jun. 1, 2003. In this scenario, the final pricing date and the final delivery date are the same.

Assume further that on Sep. 14, 2002, the market price is $2.45 per bushel, and that Agricultural Producer A has 10,000 bushels available for delivery to the buyer. Agricultural Producer A delivers the 10,000 bushels to the buyer's elevator, thereby satisfying his obligation to deliver. Agricultural Producer A, however, elects to defer pricing the corn at this time, in the belief that the market price for corn will rise. Accordingly, Agricultural Producer A pays the buyer's elevator a storage fee of 2 cents per bushel per month until the corn is priced.

On Sep. 20, 2002, the market price reaches $2.60 per bushel. Agricultural Producer A believes the market price is not likely to rise much higher, or that the market price is unlikely to rise quickly enough to cover the ongoing carrying charges. So, on Sep. 20, 2002, Agricultural Producer A prices the corn by notifying the buyer. The cash price received by Agricultural Producer A is based upon the market price of $2.60 per bushel. Storage fees are deducted from the cash price payment to Agricultural Producer A. In addition to the cash price Agricultural Producer A receives at delivery, Agricultural Producer A also received an up-front premium on his first quantity.

As a second example, assume that on Nov. 1, 2001, a buyer and Agricultural Producer B enter into an agreement, in which Agricultural Producer B agrees to sell, price and deliver a quantity of 10,000 bushels to the buyer. Unlike Agricultural Producer A, who had 10,000 bushels of corn on hand to sell to the buyer at the time the agreement was made, Agricultural Producer B has no currently available agricultural product to sell and therefore cannot receive a premium on any current agricultural product. Instead of a premium on a quantity of current agricultural product, the buyer provides consideration to Agricultural Producer B is in the form of an up-front cash payment of $ 1,000.

Under the terms of the agreement, Agricultural Producer B agrees to sell, price and deliver 10,000 bushels of his future production. The target date for pricing and delivering of Agricultural Producer B's future production is Sep. 14, 2002, and the price for the bushels will be market price or $2.50 per bushel, whichever is lower. If the market price is below $2.50 per bushel on Sep. 14, 2002, Agricultural Producer B may elect to defer pricing and/or delivery to a date after the target date, but in no event may pricing and/or delivery be deferred beyond Jun. 1, 2003.

Assume further that on Sep. 14, 2002, the market price is $2.45 per bushel. Unlike Agricultural Producer A, however, Agricultural Producer B elects not to defer pricing and delivery. Agricultural Producer B has an immediate need for cash and in any event does not believe the market price will increase sufficiently to cover the carrying charges. Accordingly, Agricultural Producer B delivers the 10,000 bushels to the buyer's elevator and receives a cash price based upon $2.45 per bushel. Like Agricultural Producer A, Agricultural Producer B receives not only his cash price under the agreement but also additional consideration, i.e., an up-front cash payment.

In a third example, a buyer and Agricultural Producer C enter into an agreement like the agreements with Agricultural Producers A and B in the previous examples. Unlike the up-front consideration provided to Agricultural Producers A and B, however, the consideration provided to Agricultural Producer C is in the form of a ten cent per bushel basis adjustment upon delivery.

In this scenario, the subsequent growing season is a normal one, and the market price on Sep. 14, 2002, is not close to the maximum price. Rather, the market price on Sep. 14, 2002, is $2.20 per bushel. Agricultural Producer C expects that the market price will decline in the next two months, or that it is unlikely that the market price will rise enough to offset carrying charges or other expenses. Accordingly, Agricultural Producer C has little incentive to defer pricing and delivery, and delivers the 10,000 bushels to the buyer's elevator and receives a cash price based upon $2.20 per bushel.

Assume that Agricultural Producer C has not previously established his basis. Assume also that the basis at the buyer's elevator at the time of delivery is “forty under,” i.e., the elevator pays forty cents per bushel below the referenced futures price, i.e., the market price. Because of the agreed-upon basis adjustment, however, the basis for Agricultural Producer C is “thirty under,” thereby increasing the cash price paid to Agricultural Producer C.

In a fourth example, Agricultural Producer D agrees to sell, price and deliver 10,000 bushels of corn to a buyer under terms like those available to Agricultural Producers A, B and C. Agricultural Producer D receives an up-front cash payment from the buyer as consideration. On Sep. 14, 2002, the market price is $2.20 per bushel. Agricultural Producer D, however, anticipates that the market price will rise considerably in or around December.

In addition, Agricultural Producer D owns facilities for storage, allowing him to avoid elevator storage fees and making his carrying charges considerably lower than those of Agricultural Producers A, B and C. Agricultural Producer D elects to defer both pricing and delivery of the corn. On Jan. 30, 2003, the market price reaches $2.60 per bushel. Agricultural Producer D prices and delivers 10,000 bushels on Jan. 30, 2003, receiving a cash price based upon $2.60 per bushel.

In a fifth example, Agricultural Producer E agrees to sell, price and deliver 10,000 bushels of corn to a buyer under terms like those available to Agricultural Producers A, B, C and D. Agricultural Producer E receives an up-front cash payment from the buyer as consideration. The subsequent growing season is exceptionally productive, and a surplus of corn drives the market price downwards. On Sep. 14, 2002, the market price is $2.00 per bushel and is expected to decline. Agricultural Producer E, like Agricultural Producer D, elects to defer both pricing and delivery of the corn and stores the corn in his own facilities.

In January of 2003, the market price begins to rise, but Agricultural Producer E does not price or deliver the corn at that time. Instead, Agricultural Producer E hopes that the market price will rise further, making his choice to defer more financially worthwhile. Unfortunately, a more desirable market price is not forthcoming, and the final pricing date and the final delivery date are approaching. On May 10, 2003, with the market price steady but expected to decline, Agricultural Producer E prices and delivers 10,000 bushels to the buyer's elevator, receiving a cash price based upon $2.20 per bushel. Although Agricultural Producer E eventually was able to take advantage of a higher market price, the delay in receiving the cash price may have outweighed the benefit of the higher cash price. In addition, Agricultural Producer E may also have incurred expenses associated with holding the bushels that consumed the gains in the market price.

In a sixth example, Agricultural Producer F agrees to sell, price and deliver 10,000 bushels of corn to a buyer under terms like those available to Agricultural Producers A, B, C, D and E. Agricultural Producer F receives an up-front cash payment from the buyer as consideration. In the subsequent growing season, an expected shortage of corn drives the market price upwards. On Sep. 14, 2002, the market price is $2.80 per bushel and Agricultural Producer F believes the market price will rise even farther. Because the market price exceeds the maximum price, however, Agricultural Producer E cannot elect to defer pricing and delivery. Instead, Agricultural Producer F is obligated to deliver the 10,000 bushels to the buyer on Sep. 14, 2002, priced at the maximum price of $2.50 per bushel. Agricultural Producer F loses the opportunity to sell the 10,000 bushels at the higher market price on Sep. 14, 2002, and further loses the opportunity to benefit from future increases in the market price.

In a seventh example, Agricultural Producer G agrees to sell, price and deliver 10,000 bushels of corn to a buyer under terms like those available to Agricultural Producers A, B, C, D, E and F. The buyer provides consideration to Agricultural Producer G in the form of a ten cent per bushel adjustment to price upon delivery. On Sep. 14, 2002, the market price is $2.80 per bushel. Because the market price exceeds the maximum price, Agricultural Producer G cannot elect to defer pricing and delivery, and is obligated to deliver the 10,000 bushels to the buyer on Sep. 14, 2002, priced at the maximum price of $2.50 per bushel.

Although the scenario involving Agricultural Producer G is similar to the scenario involving Agricultural Producer F, Agricultural Producer G receives a larger sum upon delivery than Agricultural Producer F. Unlike Agricultural Producer F, who received consideration as an up-front cash payment, Agricultural Producer G receives consideration as an adjustment to price upon delivery. Consequently, Agricultural Producer G receives a cash price based upon the maximum price plus a premium of ten cents per bushel.

A number of embodiments of the present invention have been described. Nevertheless, it will be understood that various modifications may be made without departing from the spirit and scope of the invention. For example, the agreement may specify that the agricultural producer may elect to defer pricing and delivery when the market price is equal to the market price on the target date. When the agreement provides for consideration in the form of a premium on a second quantity, the agreement may include restrictions upon the quantities, such as specifying that the second quantity be greater than, equal to or smaller than the first quantity.

The agreement may also specify that the two quantities are different kinds of agricultural products. For example, the agricultural producer may agree to sell, price and deliver a first quantity of corn, but the consideration may be a premium on a second quantity of soybeans. The invention is not strictly limited to the particular forms of consideration described above. Nor is the buyer obligated to offer a choice of consideration to the agricultural producer. A buyer may, for example, offer an adjustment to basis as consideration, and not offer any other form of consideration such as a premium on a second quantity or an up-front payment. In general, the forms of consideration offered by the buyer are intended to be attractive inducements to agricultural producers, and what is attractive may vary from commodity to commodity or from geographical area to geographical area. These and other embodiments are within the scope of the following claims.

1. A method for transacting exchanges of agricultural products, the method comprising:
providing consideration to an agricultural producer;
defining a quantity of an agricultural product, a maximum price and a target date;
receiving an election from the agricultural producer to defer pricing of the quantity beyond the target date in the event the market price is less than the maximum price on the target date; and
receiving notification from the agricultural producer of pricing of the quantity.

2. The method of claim 1, further comprising paying to the agricultural producer a sum based upon the maximum price in the event the market price exceeds the maximum price on the target date.

3. The method of claim 1, further comprising:
defining a final delivery date; and
receiving delivery of the quantity no later than the final delivery date.

4. The method of claim 1, further comprising:
defining a final pricing date; and
receiving notification from the agricultural producer of pricing of the quantity no later than the final pricing date.

5. The method of claim 4, further comprising defining a final delivery date, wherein the final pricing date and the final delivery date are the same date.

6. The method of claim 1, further comprising receiving delivery of the quantity prior to receiving notification from the agricultural producer of pricing of the quantity.

7. The method of claim 6, further comprising receiving a fee for storage of the quantity.

8. The method of claim 1, further comprising:
receiving notification from the agricultural producer of pricing of the quantity on a pricing date, the pricing date occurring after the target date; and
paying to the agricultural producer a sum based upon the market price on the pricing date.

9. The method of claim 8, wherein the market price exceeds the maximum price.

10. The method of claim 1, wherein the quantity of agricultural product is a first quantity of a first agricultural product, and wherein providing consideration comprises:
receiving delivery of a second quantity of a second agricultural product;
paying a sum to the agricultural producer based upon a market price of the second quantity plus a premium.

11. The method of claim 1, wherein providing consideration comprises:
paying a sum to the agricultural producer based upon a market price of the quantity plus a premium.

12. The method of claim 1, wherein providing consideration comprises paying a cash sum to the agricultural producer.

13. The method of claim 1, wherein providing consideration comprises an adjustment to basis.

14. A method for transacting exchanges of agricultural products, the method comprising:
receiving consideration from a buyer;
defining a quantity of an agricultural product, a maximum price and a target date;
electing to defer pricing of the quantity beyond the target date in the event the market price is less than the maximum price on the target date; and
notifying the buyer of pricing of the quantity.

15. The method of claim 14, further comprising receiving a sum from the buyer based upon the maximum price in the event the market price exceeds the maximum price on the target date.

16. The method of claim 14, further comprising:
defining a final delivery date; and
delivering the quantity no later than the final delivery date.

17. The method of claim 14, further comprising:
defining a final pricing date; and
notifying the buyer of pricing of the quantity no later than the final pricing date.

18. The method of claim 14, wherein delivering the quantity comprises delivering the quantity before notifying the buyer of pricing of the quantity.

19. A method comprising:
paying a first sum for a first quantity of a first agricultural product delivered on a first date, wherein the first sum is based on a first market price for a first delivery date plus a premium; and
paying a second sum for a second quantity of a second agricultural product, wherein the second sum is based on:
the lesser of a second market price for a second date and a maximum price in the event the second quantity is priced on the second date, or
a third market price for a third date in the event the second quantity is priced on the third date, the third date following the second date; and receiving delivery of the second quantity at no later than a final delivery date.

20. The method of claim 19, wherein the third date is no later than a final pricing date.

21. The method of claim 19, wherein the second quantity is priced on the second date in the event the maximum price exceeds the second market price on the second date.

22. The method of claim 21, wherein pricing the second quantity on the second date comprises basing the second sum on the maximum price.

23. The method of claim 19, wherein delivery of the second quantity is received before the third date.

24. The method of claim 19, wherein the first date and the second date are the same date.

25. A method comprising:
defining a quantity of an agricultural product, a maximum price and a target date;
paying to the agricultural producer a sum based upon the maximum price in the event the market price exceeds the maximum price on the target date; and
granting to the agricultural producer the choice to defer pricing of the quantity beyond the target date in the event the market price is less than the maximum price on the target date.

27. The method of claim 25, further comprising:
defining a final delivery date; and
receiving delivery of the quantity no later than the final delivery date.

27. The method of claim 25, further comprising:
defining a final pricing date; and
receiving notification from the agricultural producer of pricing of the quantity no later than the final pricing date.

28. The method of claim 25, further comprising providing consideration to the agricultural producer.

29. The method of claim 25, further comprising:
receiving notification from the agricultural producer of pricing of the quantity on a pricing date, the pricing date occurring after the target date; and
paying to the agricultural producer a sum based upon the market price on the pricing date.
